(19) United States
(12) Patent Application Publication
(10) Pub. No.: US 2025/0351188 A1
(43) Pub. Date: Nov. 13, 2025

(54) TIMING ADVANCE UPDATE FOR RELAXED DEACTIVATED CELLS

(71) Applicant: QUALCOMM Incorporated, San Diego, CA (US)

(72) Inventors: Yan ZHOU, San Diego, CA (US); Fang YUAN, Beijing (CN); Mostafa KHOSHNEVISAN, San Diego, CA (US); Shaozhen GUO, Beijing (CN); Tao LUO, San Diego, CA (US)

(21) Appl. No.: 18/871,400

(22) PCT Filed: Jul. 29, 2022
(86) PCT No.: PCT/CN2022/108997

§ 371 Date: Dec. 3, 2024

(51) Int. Cl. H04W 74/0833; H04W 52/24; H04W 52/36; H04W 56/00; H04W 72/02; H04W 72/0457; H04W 76/20

(52) U.S. Cl. CPC H04W 74/0833; H04W 52/242; H04W 52/367; H04W 56/0015; H04W 56/0045; H04W 72/02; H04W 72/0457; H04W 76/20

(57) ABSTRACT

Certain aspects of the present disclosure provide techniques for updating timing advance (TA) values for deactivated cells. In an exemplary method, a user equipment receives a first command to transmit a physical random access channel (PRACH) on a first cell that is deactivated; and transmits the PRACH on the first cell in response to the first command.

### BACKGROUND

### Field of the Disclosure

Aspects of the present disclosure relate to wireless communications, and more particularly, to techniques for updating timing advance (TA) values for deactivated cells.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a first command to transmit a physical random access channel (PRACH) on a first cell that is deactivated; and transmitting the PRACH on the first cell in response to the first command.

Another aspect provides a method for wireless communication by a network entity. The method includes transmitting a command for a UE to transmit a physical random access channel (PRACH) on a first cell that is deactivated; and transmitting an indication of a timing advance (TA) for the UE for the first cell based on the PRACH.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram for a 4-step random access channel (RACH) procedure.

FIG. 6 depicts a call flow diagram for a 2-step RACH procedure.

FIG. 7 illustrates a mobility scenario, according to aspects of the present disclosure.

FIG. 8 illustrates a timeline for performing a TA update, according to a conventional technique.

FIG. 9 depicts a process flow for communications in a network between a network entity, a user equipment (UE), and a candidate cell, which is a deactivated cell, according to aspects of the present disclosure.

FIG. 10 depicts a table of five alternative techniques for performing a TA update on a deactivated cell, according to aspects of the present disclosure.

FIG. 11 is a timeline showing activities by a special cell (SpCell) and a UE, according to aspects of the present disclosure.

FIGS. 12A and 12B illustrate scenarios for selection of a beam for receiving and transmitting Msg2, Msg3, and Msg4, according to aspects of the present disclosure.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for updating timing advance (TA) values for deactivated cells.

A TA is used for time synchronization and determines when the UE sends an uplink transmission. The TA allows the UE to adjust the timing of an UL transmission in order to align the UL transmission with future transmissions in time domain. In other words, the TA values are designed to ensure the uplink transmissions arrive at a transmission/reception point (TRP) aligned with a boundary of a time slot. A values are typically determined via a random access channel (RACH) procedure, wherein a UE sends a first message referred to as a physical RACH (PRACH) preamble to a network entity (e.g., a base station). The network entity responds with a random access response (RAR) message (MSG2) which may include the TA value.

When a UE is moving in a network, the UE may move from an area served by a first cell into a new area served by another cell. In order to communicate with the new cell, the UE must have information regarding a TA for the new cell. Becoming active on the new cell therefore typically involves some latency as the UE begins a random access procedure on the new cell and receives a TA for the new cell. If the UE had the TA before becoming active on the new cell, there would be less latency and communications would be more reliable, but in conventional systems, PRACH is not supported on a cell that is deactivated for the UE.

Techniques provided in the present disclosure enable a UE to transmit a PRACH on a deactivated cell and receive a TA update for the deactivated cell. By enabling a UE to receive a TA update for a deactivated cell, the UE may be able to begin communications with that cell more quickly, which may reduce latency and improve reliability of UE to network communications when the UE is moving.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

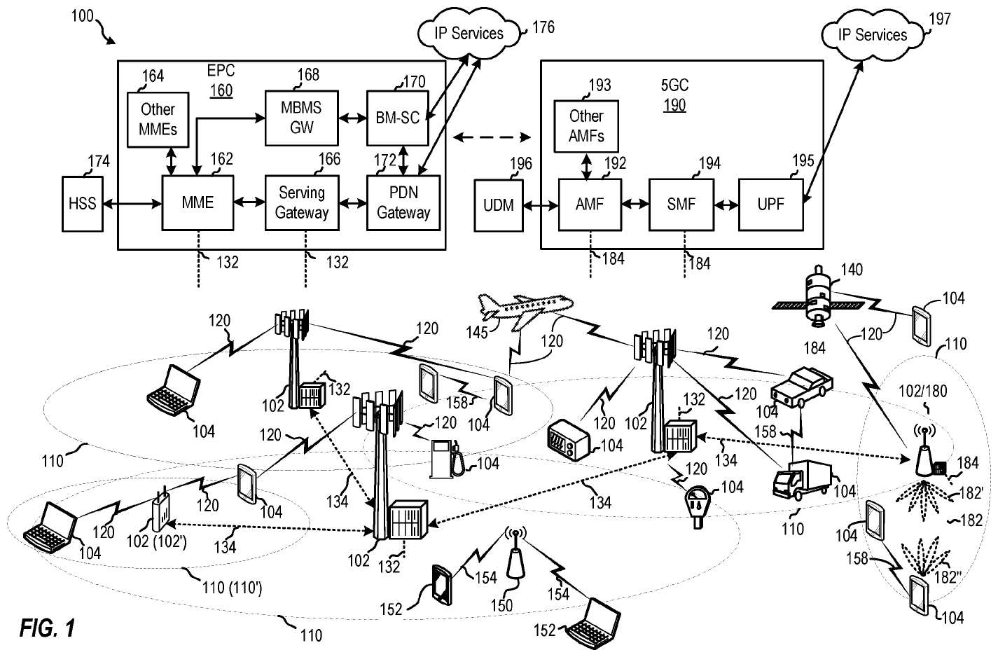

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

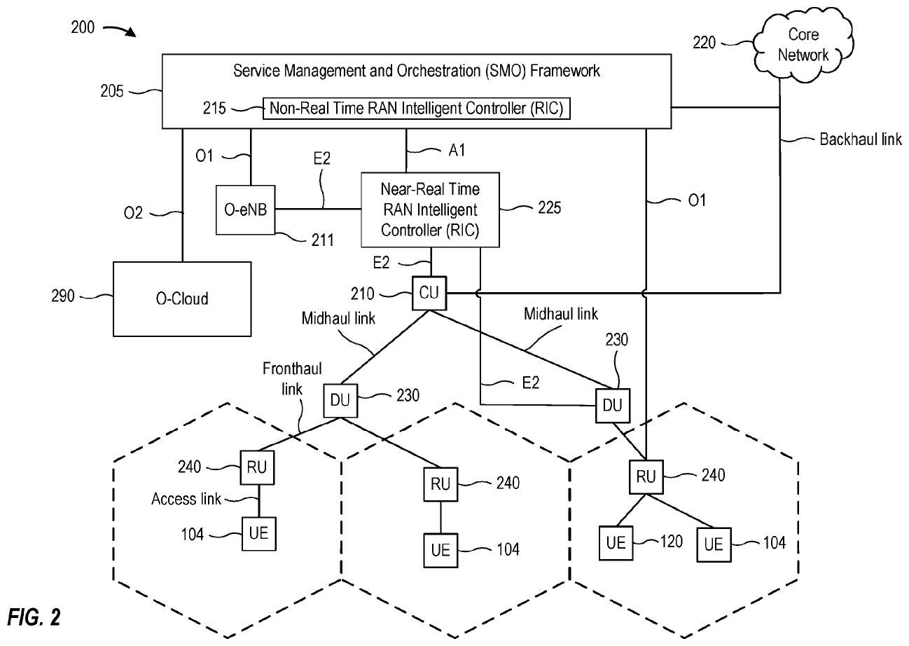

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

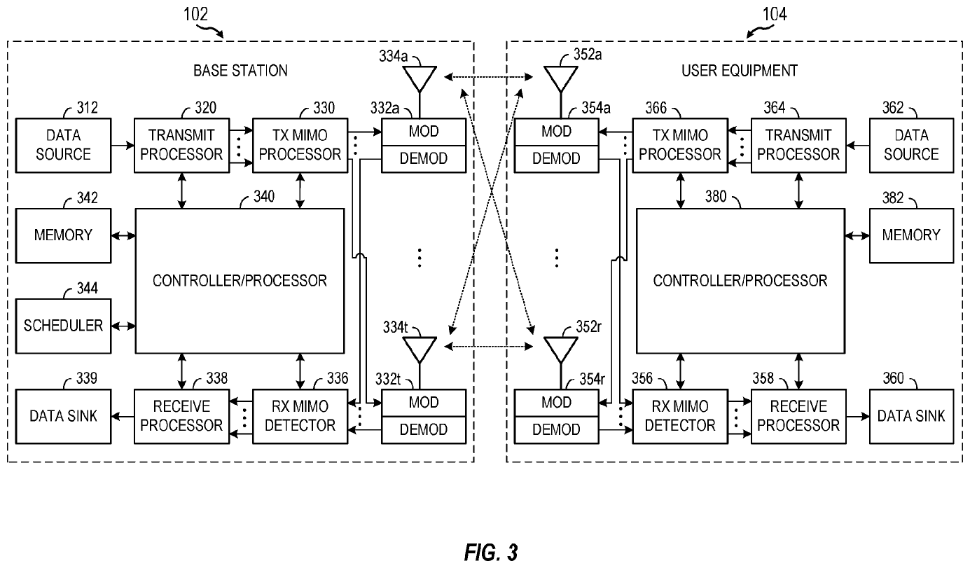

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

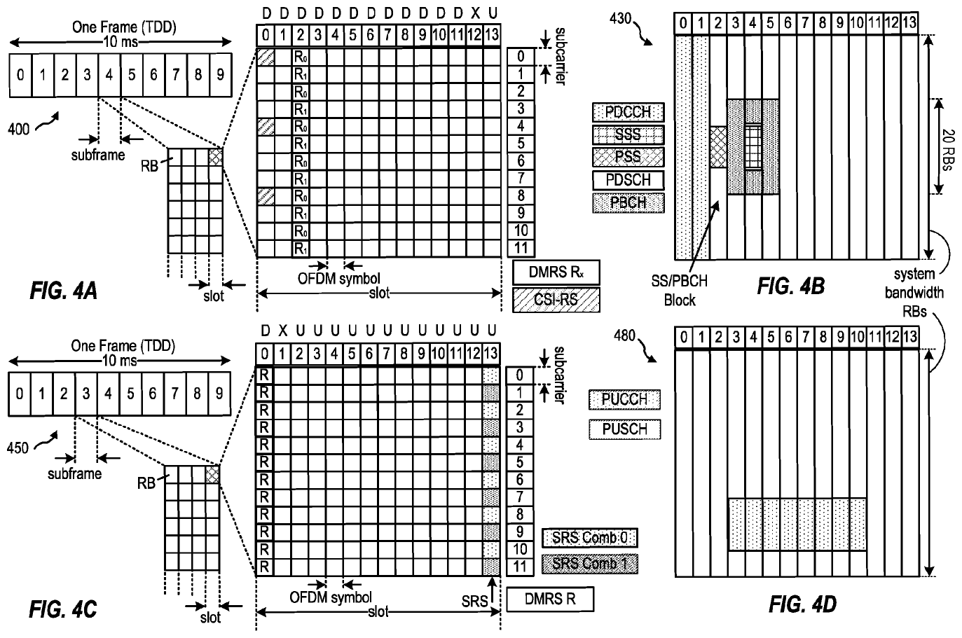

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example RACH Procedures

A random access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

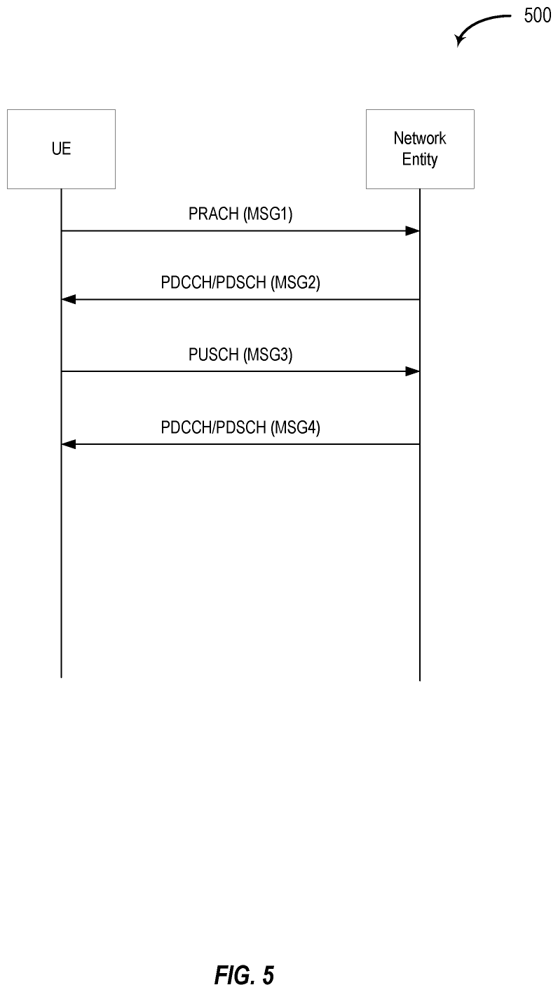

FIG. 5 is a timing (or “call-flow”) diagram 500 illustrating an example four-step RACH procedure, in accordance with certain aspects of the present disclosure. A first message (MSG1) may be sent from the UE to a network entity (e.g., a BS such as a gNB) on the physical random access channel (PRACH). In this case, MSG1 may only include a RACH preamble. The network entity may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a PDCCH communication including control information for a following communication on the PDSCH, as illustrated. In response to MSG2, MSG3 is transmitted from the UE to the network entity on the PUSCH. MSG3 may include one or more of a RRC connection request, a tracking area update request, a system information request, a positioning fix or positioning signal request, or a scheduling request. The network entity then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

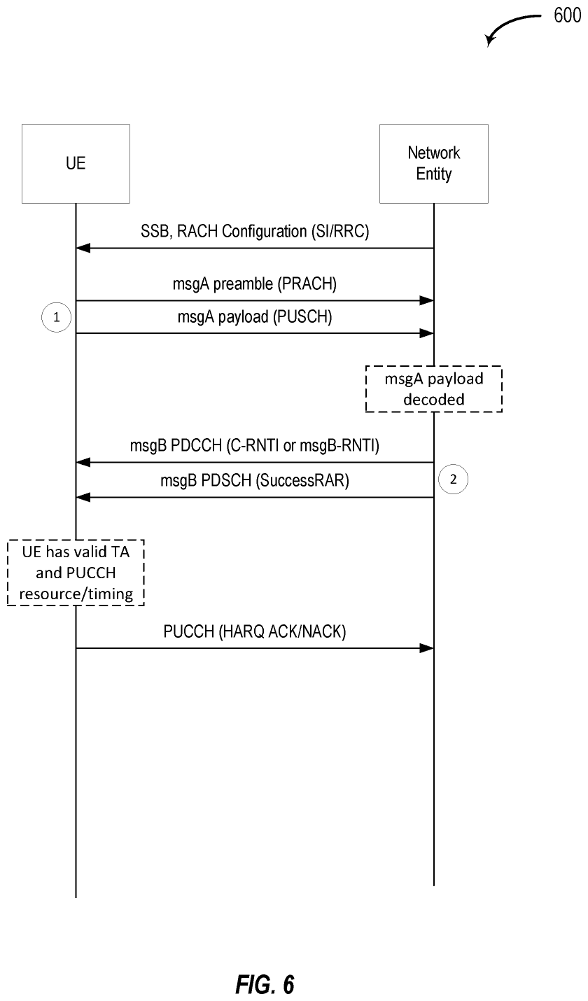

FIG. 6 is a call flow diagram 600 illustrating an example two-step RACH procedure, in accordance with certain aspects of the present disclosure. As illustrated, the UE may be configured with parameters, via system information (SI) and/or RRC signaling, for SSB monitoring and RACH procedure.

For the 2-step RACH procedure, a first enhanced message (msgA) may be sent from the UE to the network entity. In certain aspects, msgA includes some or all the information from MSG1 and MSG3 from the four-step RACH procedure, effectively combining MSG1 and MSG3. For example, msgA may include MSG1 and MSG3 multiplexed together such as using one of time-division multiplexing or frequency-division multiplexing. In certain aspects, msgA includes a RACH preamble for random access and a payload. The msgA payload, for example, may include the UE-ID and other signaling information (e.g., buffer status report (BSR)) or scheduling request (SR). The BS may respond with a random access response (RAR) message (msgB) which may effectively combine MSG2 and MSG4 described above. For example, msgB may include the ID of the RACH preamble, a timing advance (TA), a back off indicator, a contention resolution message, UL/DL grant, and transmit power control (TPC) commands.

In a two-step RACH procedure, the msgA may include a RACH preamble and a payload. In some cases, the RACH preamble and payload may be sent in a msgA transmission occasion.

The random access message (msgA) transmission occasion generally includes a msgA preamble occasion (for transmitting a preamble signal) and a msgA payload occasion for transmitting a PUSCH. The msgA preamble transmission generally involves:
(1) selection of a preamble sequence; and
(2) selection of a preamble occasion in time/frequency domain (for transmitting the selected preamble sequence).
   The msgA payload transmission generally involves:
(1) construction of the random access message payload (DMRS/PUSCH); and
(2) selection of one or multiple PUSCH resource units (PRUs) in time/frequency domain to transmit this message (payload).

In some cases, a UE monitors SSB transmissions which are sent (by a gNB using different beams) and are associated with a finite set of time/frequency resources defining RACH occasions (ROs) and PRUs. Upon detecting an SSB, the UE may select an RO and one or more PRUs associated with that SSB for a MSG1/msgA transmission.

There are several benefits to a two-step RACH procedure, such as speed of access and the ability to send a relatively small amount of data without the overhead of a full four-step RACH procedure to establish a connection (when the four-step RACH messages may be larger than the payload).

The two-step RACH procedure can operate in any RRC state and any supported cell size. Networks that uses two-step RACH procedures can typically support contention-based random access (CBRA) transmission of messages (e.g., msgA) within a finite range of payload sizes and with a finite number of MCS levels.

After a UE has selected an SSB (beam), for that SS block there is a predefined one or more ROs with certain time and frequency offset and direction (e.g., specific to the selected SSB).

This SSB to RO association is used for the gNB to know what beam the UE has acquired/is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

### Overview of L1/L2 Based Mobility

For L1/L2 based mobility, a network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily be used for data and control transfer. The network may also configure (signal) an L1/L2 Mobility Deactivated cell set, which refers to a group of cells in in the configured set that are deactivated and can be readily be activated by L1/L2 signaling.

L1/L2 signaling may be used for mobility management of the activated set. For example, L1/L2 signaling may be used to activate/deactivate cells in the set, select beams within the activated cells, and update/switch a PCell. This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

In some cases, all cells in the L1/L2 Mobility Configured cell set may belong to the same DU. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

In some cases, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For primary cell (PCell) management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

### Aspects Related to Updating Timing Advances for Deactivated Cells

In systems that support L1/L2 based mobility, it may be beneficial for a UE to maintain a timing advance (TA) on a candidate primary cell (PCell), such that no TA update is needed after the candidate PCell is selected as the new PCell. As noted above, however, in conventional systems, PRACH is not supported on a cell that is deactivated.

In conventional systems, a UE does not transmit a PRACH, sounding reference signals (SRS), or a physical uplink control channel (PUCCH) on a deactivated primary secondary cell (PSCell) nor on a deactivated secondary cell (SCell). In addition, with conventional techniques, a UE will not receive a physical downlink control channel (PDCCH) on or for the deactivated SCell that is a candidate PCell and will not report CSI for the deactivated SCell that is the candidate PCell.

Accordingly, aspects of the present disclosure provide techniques for updating a TA for a deactivated cell. The provided techniques include the UE receiving a command to transmit a PRACH on a first cell that is deactivated and transmitting the PRACH on the first cell in response to the command. The provided techniques further include the UE receiving a TA determined based on the PRACH and transmitting a signal to the first cell using the TA.

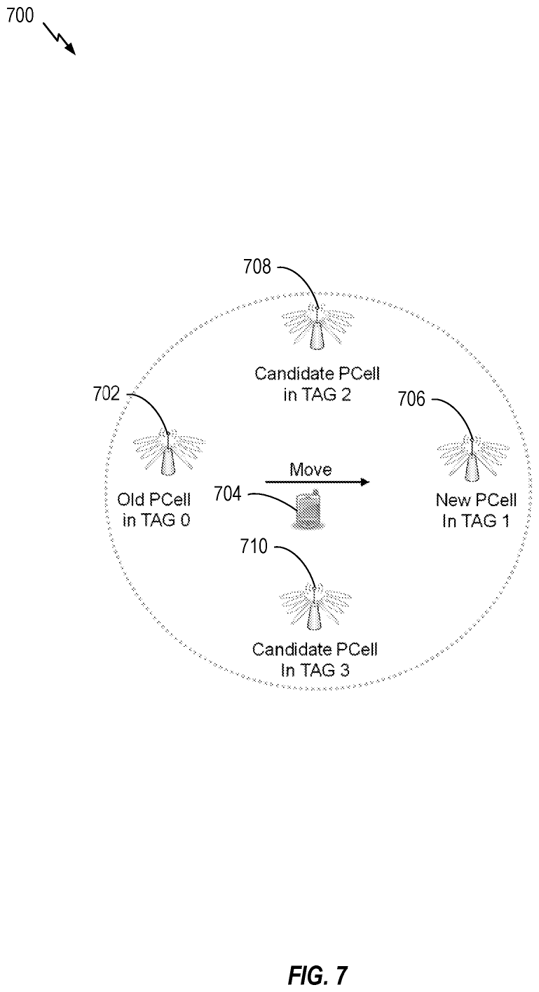

FIG. 7 illustrates a mobility scenario 700 in which a UE 704 moves away from a PCell 702 and is indicated to switch/reselect to a new PCell among a set of pre-configured candidate PCells 706, 708, and 710 that are determined based on the UE's L1 measurements for those cells, according to aspects of the present disclosure. As illustrated, the PCell 702 is in a timing advance group (TAG) 0, while the candidate PCells 706, 708, and 710 are in TAG 1, TAG 2, and TAG 3, respectively. In the illustrated scenario, the candidate PCells are not activated before one of them is selected as the new PCell. In the illustrated scenario, candidate PCell 706 is selected as the new PCell, and no other cells (not shown) in TAG 1 are activated.

According to aspects of the present disclosure, the UE may transmit a PRACH to any of the deactivated candidate PCells and receive a TA update for the deactivated candidate PCell based on the PRACH. The TA update may be determined by a gNB and transmitted to the UE by a special cell (SpCell) of the UE or by the candidate PCell.

In conventional systems, to update TA for a cell, the cell may be activated, the UE performs a PRACH on the activated cell, the UE receives a TA update for the cell, and the UE may then deactivate the cell, once the TA update is finished.

The provided techniques are advantageous as compared with the above process, in that the UE only prepares and makes the PRACH transmission on the deactivated cell and does not prepare other functions, such as PDCCH monitoring, CSI reporting, HARQ processing, and the like. So, both the UE complexity and power consumption to maintain such a deactivated cell may be reduced as compared to the above process, and a gNB may trigger the UE to transmit a PRACH on a deactivated cell at any time with lower latency and power consumption by the UE than would be used in fully activating the candidate cell. This process resembles processes for radio link monitoring (RLM), beam failure detection (BFD), and transmission control indication (TCI) activation on deactivated SpCells that have been introduced in certain systems.

In another conventional technique, a TA update for a deactivated candidate SpCell may be derived based on a reception timing difference between the current active SpCell and the deactivated candidate SpCell. However, this technique may not be accurate if the DL transmission timing difference between the active SpCell and the deactivated candidate SpCell is large and unknown by the gNB, which may be a typical case, especially when the active SpCell and the deactivated candidate SpCell are on different frequencies.

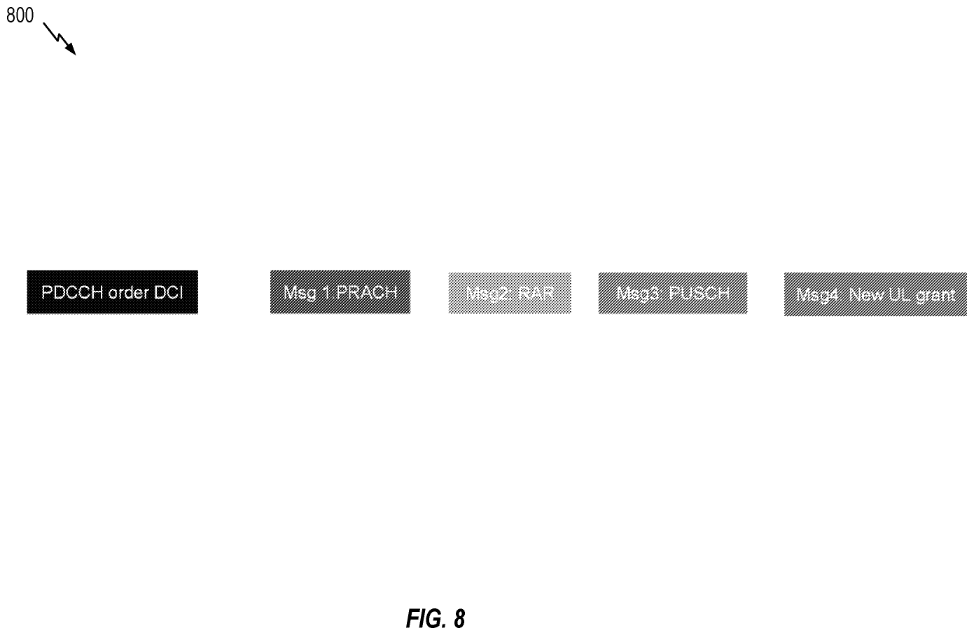

FIG. 8 illustrates a timeline 800 for a conventional technique of performing a TA update. In the conventional technique, a TA update based on a PRACH contains 5 steps. In the first step, a gNB sends a PDCCH containing DCI directing the UE to transmit perform a TA update for a cell. In the second step, the UE transmits a PRACH (also referred to as message 1 (Msg1) of a RACH procedure) on the cell for which the TA is being updated. In the third step, the gNB sends a random access response (RAR, also referred to as a message 2 (Msg2) of the RACH procedure) including a TA command, which is applied by the UE to the corresponding TAG for the cell. In the fourth step, the UE transmits a PUSCH (also referred to as a message 3 (Msg3) of the RACH procedure), which includes a cell-specific radio network temporary identifier (C-RNTI) medium access control control element (MAC-CE) for the UE when the random access procedure is a contention-based random access (CBRA) and buffer status report (BSR) or data when the random access procedure is a contention-free random access (CFRA). In the fifth step, for a CBRA, the gNB responds to the PUSCH with DCI scrambled by the C-RNTI of the UE and scheduling a new UL grant for the UE.

In the conventional technique described above, the PDCCH containing the DCI directing the UE to perform the TA update can be sent from an SCell for an SCell TA update, and the UE transmits the PRACH to that SCell. The other transmissions in the third, fourth, and fifth steps are sent to or from the SpCell for the UE.

In the conventional technique, the PDCCH containing the DCI directing the UE to perform the TA update can trigger the UE to perform a CFRA or a CBRA. When the PDCCH triggers the UE to perform a CFRA, the PRACH preamble, synchronization signal block (SSB), and RACH occasion (RO) are also signaled to the UE in the PDCCH. When the PDCCH triggers the UE to perform a CBRA, the PRACH preamble, SSB, and RO are all determined by the UE. In a CBRA, if the message in the fifth step (Msg4) is not received before a contention resolution timer at the UE expires, then the UE ignores the TA in the message received in the third step (Msg2).

As noted above, in conventional systems, a UE cannot transmit PRACH on nor monitor PDCCH on or for a deactivated SCell nor on or for a deactivated PSCell.

In aspects of the present disclosure, a UE can transmit a PRACH on a deactivated cell in order to perform a PRACH based TA update for a TAG including the deactivated cell. The PRACH transmission may be part of a CFRA or a CBRA.

According to certain aspects of the present disclosure, a UE may both monitor PDCCH and receive PDSCH on or for a deactivated cell to enable the UE to receive a Msg2 of a RACH procedure as part of a PRACH based TA update for the deactivated cell. The UE may transmit a Msg3 of a RACH procedure to the deactivated cell, and the UE may receive a Msg4 from the deactivated cell. In certain aspects of the present disclosure, a UE may be restricted to transmitting to and receiving from deactivated cells only for L1 or L2 based serving cell activation or selection, e.g., only when the deactivated cell is a candidate SpCell for the UE.

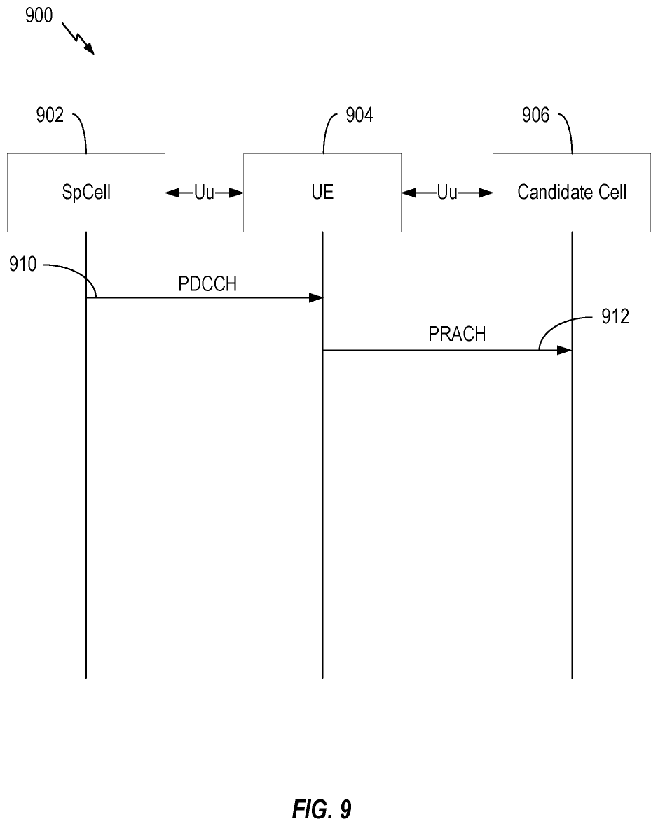

FIG. 9 depicts an example call flow diagram 900 for communications in a network between a network entity (e.g., an SpCell 902), a user equipment (UE) 904, and a candidate cell 906, which is a deactivated cell. In some aspects, the network entity may be an example of the BS 102 depicted and described with respect to FIGS. 1 and 3 or a disaggregated base station depicted and described with respect to FIG. 2. Similarly, the UE may be an example of UE 104 depicted and described with respect to FIGS. 1 and 3. However, in other aspects, the UE may be another type of wireless communications device and the network entity may be another type of network entity or network node, such as those described herein.

As illustrated, at 910, the SpCell 902 may transmit a PDCCH to UE 904 commanding the UE to perform a PRACH based TA update for the candidate cell 906, which is a deactivated cell. At 912, in response to the PDCCH, the UE transmits a PRACH to the candidate cell.

In the provided techniques, each of the messages in the five steps shown in FIG. 8 may be sent to or received from either the SpCell or the deactivated candidate PCell.

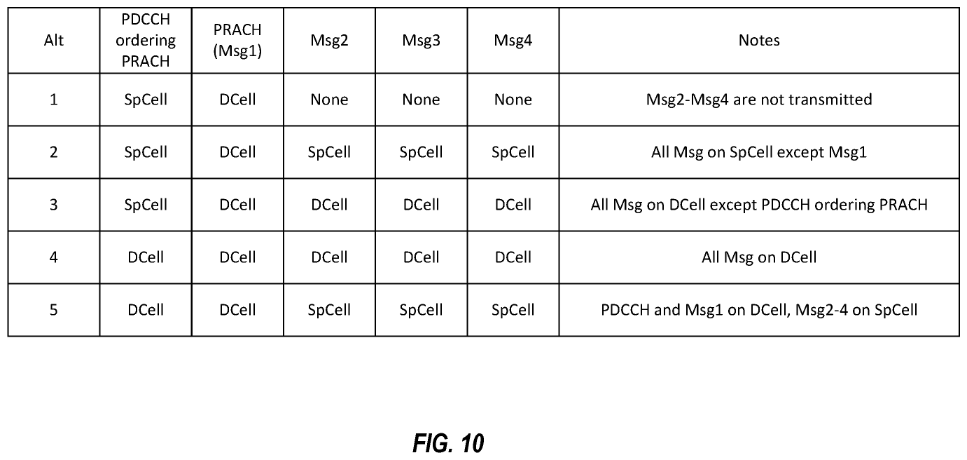

FIG. 10 depicts a table of five alternative techniques for performing a TA update on a deactivated cell, according to aspects of the present disclosure. In the table, SpCell refers to a special cell for the UE that is an active cell, and DCell refers to the deactivated cell for which the TA update is to be performed. In the first alternative, the PDCCH ordering the PRACH (the first step shown in FIG. 8) is transmitted by the SpCell, and the UE transmits the PRACH (the second step shown in FIG. 8) to the deactivated cell. In the first alternative, the other steps shown in FIG. 8 are not performed, and the TA for the deactivated cell is sent to the UE when the deactivated cell is activated.

In the second alternative in FIG. 10, the PDCCH ordering the PRACH (the first step shown in FIG. 8) is transmitted by the SpCell, and the UE transmits the PRACH (the second step shown in FIG. 8) to the deactivated cell. The SpCell then transmits Msg2 of the RACH procedure (the third step shown in FIG. 8) to the UE. Next, the UE transmits Msg3 of the RACH procedure (the fourth step shown in FIG. 8) to the SpCell. Finally, the SpCell transmits Msg4 (the fifth step shown in FIG. 8) to the UE.

In the third alternative in FIG. 10, the PDCCH ordering the PRACH (the first step shown in FIG. 8) is transmitted by the SpCell, and the UE transmits the PRACH (the second step shown in FIG. 8) to the deactivated cell. The deactivated cell then transmits Msg2 of the RACH procedure (the third step shown in FIG. 8) to the UE. Next, the UE transmits Msg3 of the RACH procedure (the fourth step shown in FIG. 8) to the deactivated cell. Finally, the deactivated cell transmits Msg4 (the fifth step shown in FIG. 8) to the UE.

In the fourth alternative in FIG. 10, the PDCCH ordering the PRACH (the first step shown in FIG. 8) is transmitted by the deactivated cell, and the UE transmits the PRACH (the second step shown in FIG. 8) to the deactivated cell. The deactivated cell then transmits Msg2 of the RACH procedure (the third step shown in FIG. 8) to the UE. Next, the UE transmits Msg3 of the RACH procedure (the fourth step shown in FIG. 8) to the deactivated cell. Finally, the deactivated cell transmits Msg4 (the fifth step shown in FIG. 8) to the UE.

In the fifth alternative in FIG. 10, the PDCCH ordering the PRACH (the first step shown in FIG. 8) is transmitted by the deactivated cell, and the UE transmits the PRACH (the second step shown in FIG. 8) to the deactivated cell. The SpCell then transmits Msg2 of the RACH procedure (the third step shown in FIG. 8) to the UE. Next, the UE transmits Msg3 of the RACH procedure (the fourth step shown in FIG. 8) to the SpCell. Finally, the SpCell transmits Msg4 (the fifth step shown in FIG. 8) to the UE.

In conventional techniques, a PDCCH ordered PRACH is transmitted by a UE on an active UL bandwidth part (BWP) with a PRACH transmit power determined based on parameters or reference signals (RS) configured for the active UL/DL BWPs, as follows. The PRACH is transmitted on the active UL BWP. The target PRACH received power is the same as the target received power configured for the active UL BWP. When calculating the target received power for the PRACH, path loss is computed based on a PL RS and transmit power for the PL RS. The PL RS is the DL RS associated with the PRACH transmission in the active DL BWP. Except that, for SSB, the DL RS may not be in the active DL BWP, if the active DL BWP is the initial BWP with multiplexing pattern 2 or 3. The transmit power for the PL RS is the transmit power configured for the PL RS, e.g., the transmit powers configured by the RRC parameters ss-PBCH-BlockPower for SSB and powerControlOffsetSS for CSI-RS, except for a PDCCH ordered CFRA. For a PDCCH ordered CFRA, the transmit power for the PL RS is the transmit power configured for one quasi-collocated (QCL) RS of the PDCCH demodulation reference signal (DMRS) for the PDCCH order. If the TCI of the PDCCH only has one QCL RS, then the transmit power of that QCL RS is used. If the TCI of the PDCCH has two QCL RSs, then the transmit power of a QCL-TypeD RS is used.

In aspects of the present disclosure, for a PRACH transmission on a deactivated cell, there is no active BWP and, hence, the PRACH power control parameters determination may be based on corresponding DL and UL BWPs that are specified for the PRACH transmission, as well as a corresponding power control parameter determination.

In certain aspects of the present disclosure, the corresponding DL and UL BWPs may be determined by a rule. For example, the corresponding DL and UL BWPs for power control parameters determination for the PRACH on a deactivated cell may be the initial DL and UL BWPs. Other example rules are that the corresponding DL and UL BWPs are provided by the RRC parameters firstActiveDownlinkBWP-ID and firstActiveUplinkBWP-Id, or that the corresponding DL and UL BWPs are the DL and UL BWPs having the lowest BWP IDs, or that the corresponding DL BWP is the DL BWP having a lowest ID among the DL BWPs that have SSB transmissions, or that the corresponding UL BWP is the UL BWP with a lowest ID among UL BWPs having configured RACH occasions.

In certain aspects of the present disclosure, the corresponding DL and UL BWPs may be indicated by a gNB via radio resource control (RRC) signaling, a MAC-CE, or a DCI.

In aspects of the present disclosure, the PRACH is transmitted by the UE on the determined UL BWP, whether that UL BWP is determined by a rule or by an indication from the gNB.

In aspects of the present disclosure, the target PRACH received power is the same as the target received power configured for the above determined UL BWP, while the PL RS is the DL RS associated with the PRACH transmission in the determined DL BWP, whether that DL BWP is determined by a rule or by an indication from the gNB. As in conventional techniques, if the DL RS is and SSB, the SSB may not be in the determined DL BWP if the determined DL BWP is the initial BWP with a multiplexing pattern 2 or 3 specified in 3GPP new radio (NR) specifications.

In aspects of the present disclosure, if the DL RS is a CSI-RS, the UE may measure only the CSI-RS within the determined DL BWP when determining the path loss to use in the PRACH power control parameters determination.

According to certain aspects of the present disclosure, when determining the PRACH power control parameters, the transmit power for the PL RS used in the determination may be the transmit power configured for the PL RS, e.g. ss-PBCH-BlockPower for SSB and powerControlOffsetSS for CSI-RS, except for a PDCCH ordered CFRA. For a PDCCH ordered CFRA sent from the deactivated cell, e.g., the fourth or fifth alternative in the table in FIG. 10, the transmit power for the PL RS is the transmit power configured for one quasi-collocated (QCL) RS of the PDCCH demodulation reference signal (DMRS) for the PDCCH order. If the TCI of the PDCCH only has one QCL RS, then the transmit power of that QCL RS is used. If the TCI of the PDCCH has two QCL RSs, then the transmit power of a QCL-TypeD RS is used. For a PDCCH order sent from the SpCell, e.g., the first through third alternatives in the table in FIG. 10, the transmit power for the PL RS used in the determination for the PRACH power control parameters is the transmit power configured for the PL RS, e.g., the transmit power configured by the RRC parameters ss-PBCH-BlockPower for SSB and powerControlOffsetSS for CSI-RS.

In aspects of the present disclosure, a transmit power for the PRACH may be determined based on a power control formula that includes Pc_{max,f,c}, which is the UE configured maximum output power for the deactivated cell.

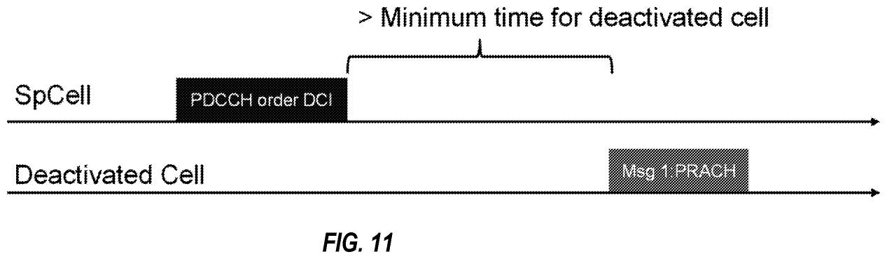

FIG. 11 is an example timeline showing activities by a SpCell and a UE, according to aspects of the present disclosure. In the timeline, a PDCCH ordering the UE to transmit a PRACH is transmitted by a SpCell. As illustrated, after a minimum elapsed time, the UE transmits the PRACH on the deactivated cell. The activities shown in the timeline match the first through third alternatives shown in the table in FIG. 10. In aspects of the present disclosure, for a PDCCH ordering a UE to transmit a PRACH on a deactivated cell sent on a SpCell, a minimum time between the PDCCH and the PRACH is defined to account for additional time for the UE to activate a transmit chain of the UE. The minimum time may depend on the frequency range for the PRACH transmission, DL and UL subcarrier spacing (SCS) of the SpCell and/or the deactivated cell, and whether there is an UL transmission on another component carrier (CC) by the UE before the PRACH is to be transmitted.

In aspects of the present disclosure, the minimum time between receiving the PDCCH and transmitting the PRACH on the deactivated cell can be determined by a fixed rule, by capabilities of the UE, or by a mix of both, e.g., some components used in a calculation of the minimum time may be determined according to a fixed rule, while other components used in the calculation of the minimum time may be determined according to capabilities of the UE.

In conventional techniques, for a single cell or for carrier aggregation (CA) of carriers that are within a same frequency band, PRACH prioritization rules are used for a PRACH transmitted on an active serving cell. Example PRACH prioritization rules include:
1) a valid RACH occasion (RO) is not expected to overlap with a DL symbol indicated by DCI format 2_0;
2) the UE is not to make a PRACH transmission if the PRACH transmission would overlap with any SSB symbol;
3) the UE is not to make a PRACH transmission if the PRACH transmission would overlap with any RRC configured DL symbol;
4) the UE is not to make a PRACH transmission if the PRACH transmission would overlap with any RRC configured flexible symbol for which no DCI format 2_0 has been detected to indicate a symbol type for that flexible symbol and the UE has not been provided with EnableConfiguredUL-r16 to indicate the type of that flexible symbol;
5) the UE is not to make a PRACH transmission if the PRACH transmission would overlap with a DL or flexible symbol indicated by DCI format 2_0;
6) the UE is not to make a PRACH transmission if the PRACH transmission would overlap with a DL signal scheduled by a PDCCH.
   One or more of the above rules may apply when the PRACH and the other signal or symbol type are on different CCs within a same frequency band.

According to aspects of the present disclosure, the above-described PRACH prioritization rules may also apply to a PRACH transmitted on a deactivated cell.

In conventional techniques, the receive beam used by the UE for receiving Msg2 PDCCH and PDSCH due to PRACH in response to a PDCCH order may be determined according to the below rules:
1) For a PDCCH order from a SpCell to trigger a CFRA on the SpCell, the UE uses the PDCCH order receive beam to receive the Msg2 PDCCH, and the UE uses the SSB or CSI-RS associated with the PRACH to receive the Msg2 PDSCH, if the PDSCH scheduling offset is longer than the time duration for QCL.
2) For a PDCCH order from a SpCell to trigger a CFRA on an SCell or a PDCCH order from the SpCell to trigger CBRA on the SpCell, the UE uses the Type1-PDCCH common search space (CSS) receive beam to receive the Msg2 PDCCH and PDSCH, if the PDCSH scheduling offset is longer than the time duration for QCL.

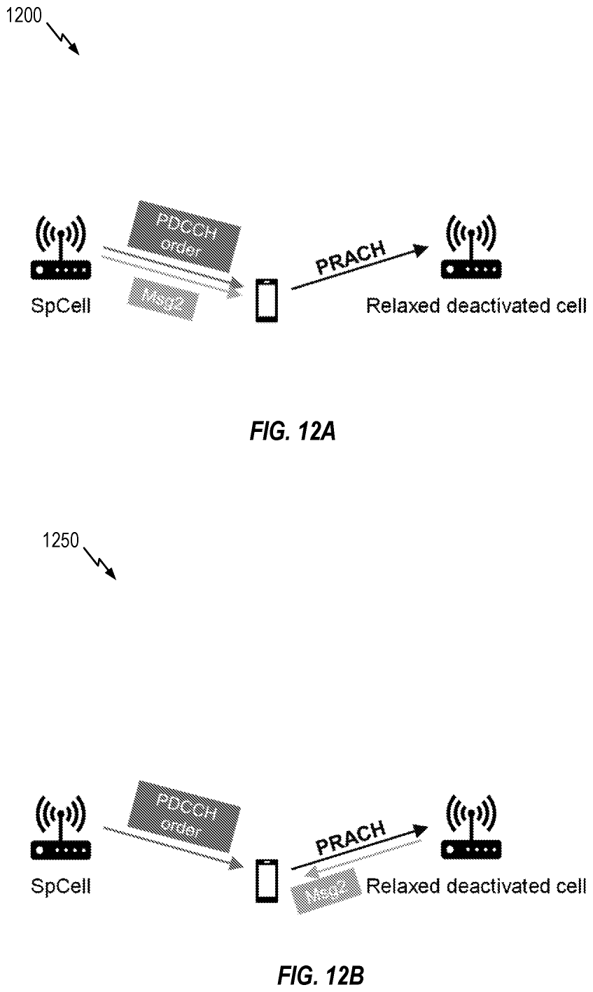

In aspects of the present disclosure, for a PRACH transmitted by a UE on a deactivated cell, the receive and/or transmit beam for the Msg2, Msg3, and Msg4 which may be related to PDCCH, PDSCH, PUSCH, or PUCCH may have various options. For example, according to a first option, the UE may use the receive beam for the PDCCH ordering the PRACH transmission as the receive and/or transmit beam for receiving or transmitting Msg2, Msg3, and Msg4. This option is applicable when the PDCCH order, Msg2, Msg3, and Msg4 are on the same cell, as shown in FIG. 12A below and the second and fourth alternatives shown in the table in FIG. 10.

According to a second option, the UE may use the beam used for receiving the SSB or CSI-RS associated with the PRACH as the transmit and/or receive beam for Msg2, Msg3, and Msg4, when the PDSCH scheduling offset is longer than a threshold “timeDurationforQCL”. This option is applicable when the PRACH, Msg2, Msg3, and Msg4 are on the same cell, as shown in FIG. 12B below and the third and fourth alternatives shown in the table in FIG. 10.

According to a third option, the UE may use the Type1-PDCCH common search space (CSS) receive beam on the deactivated cell as the receive and/or transmit beam for Msg2, Msg3, and Msg4, when the PDSCH scheduling offset is longer than a threshold “timeDurationforQCL”. This option is applicable for all of the alternatives shown in the table in FIG. 10.

FIG. 12A illustrates one example scenario for selection of a beam for receiving and transmitting Msg2, Msg3, and Msg4 when a PDCCH ordering a PRACH transmission to a deactivated cell is on a same cell as Msg2, Msg3, and Msg4 (i.e., as previously described above), according to aspects of the present disclosure. As illustrated, the PDCCH, Msg2, Msg3 (represented by Msg2), and Msg4 (also represented by Msg2) are all transmitted and received on the SpCell, and so the UE uses the receive beam for the PDCCH ordering the PRACH transmission as the receive and transmit beam for receiving or transmitting Msg2, Msg3, and Msg4.

FIG. 12B illustrates another example scenario for selection of a beam for receiving and transmitting Msg2, Msg3, and Msg4 when a PRACH transmission to a deactivated cell is on a same cell as Msg2, Msg3, and Msg4 (i.e., option 2 above), according to aspects of the present disclosure. As illustrated, the PRACH, Msg2, Msg3 (represented by Msg2), and Msg4 (also represented by Msg2) are all transmitted and received on the deactivated cell, and so the UE uses the beam used for receiving the SSB or CSI-RS associated with the PRACH as the transmit and receive beam for Msg2, Msg3, and Msg4.

In aspects of the present disclosure, if Msg2, Msg3, and Msg4 are received and transmitted on a deactivated cell (i.e. the third and fourth alternatives in the table in FIG. 10), the complexity for monitoring corresponding PDCCHs on the deactivated cell may be counted in the limit for the UE on the total monitored PDCCH candidates and non-overlapped CCEs per slot across multiple DL CCs. The UE is not required to monitor more than a predetermined number of PDCCH candidates or more than a predetermined number of non-overlapped CCEs per slot on the active DL BWP(s) of scheduling cell(s) from the activate and deactivated cells. When the number of PDCCH candidates or a number of non-overlapped CCEs per slot on the active DL BWP(s) of scheduling cell(s) from the activated and deactivated cells exceeds the predetermined number, the UE may drop or ignore some PDCCH candidates or CCEs.

### Example Operations of a User Equipment

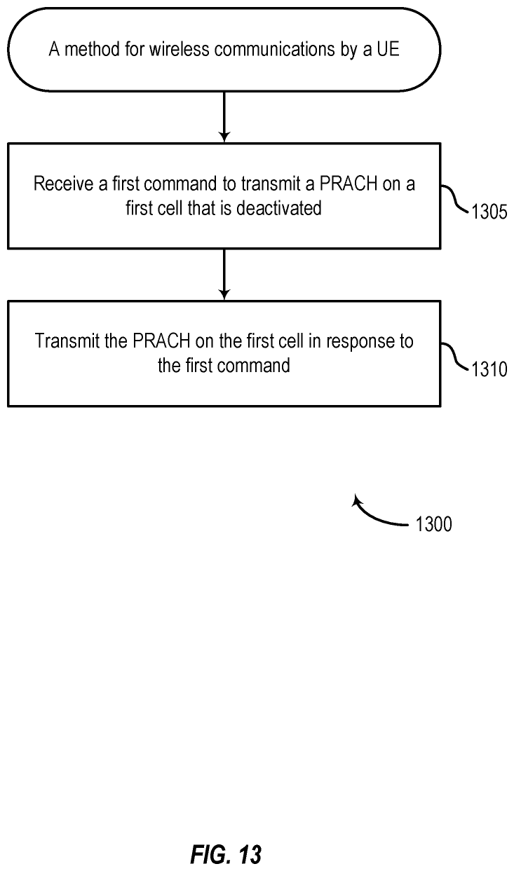

FIG. 13 shows an example of a method 1300 for wireless communications by a UE, such as a UE 104 of FIGS. 1 and 3.

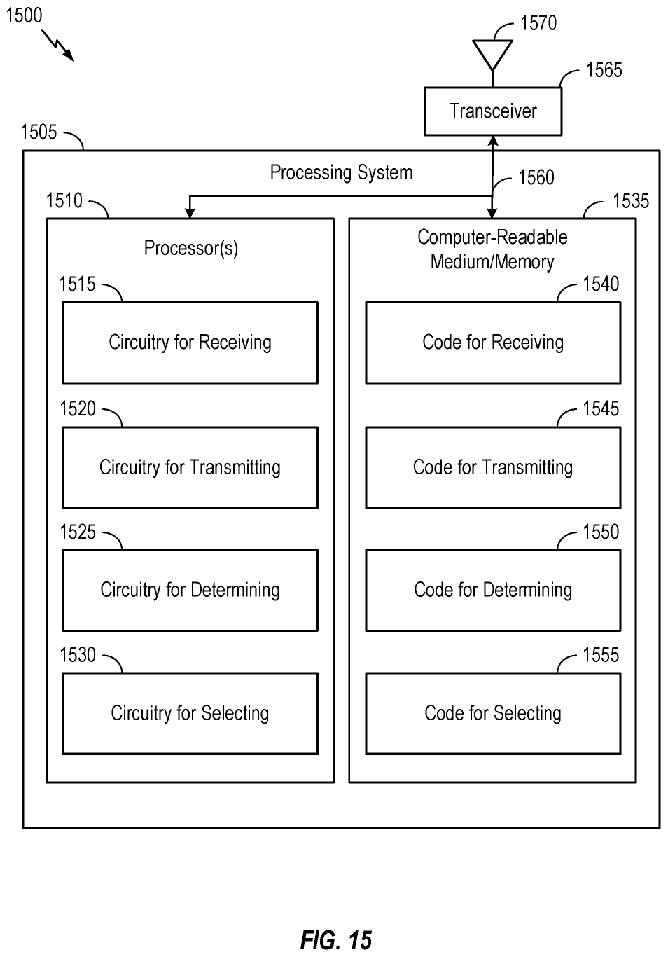

Method 1300 begins at step 1305 with receiving a first command to transmit a PRACH on a first cell that is deactivated. In some cases, the operations of this step refer to, or may be performed by, circuitry for receiving and/or code for receiving as described with reference to FIG. 15.

Method 1300 then proceeds to step 1310 with transmitting the PRACH on the first cell in response to the first command. In some cases, the operations of this step refer to, or may be performed by, circuitry for transmitting and/or code for transmitting as described with reference to FIG. 15.

In some aspects, the method 1300 further includes receiving a TA for the first cell, wherein the TA is determined based on the PRACH. In some cases, the operations of this step refer to, or may be performed by, circuitry for receiving and/or code for receiving as described with reference to FIG. 15.

In some aspects, the method 1300 further includes transmitting a signal to the first cell using the TA. In some cases, the operations of this step refer to, or may be performed by, circuitry for transmitting and/or code for transmitting as described with reference to FIG. 15.

In some aspects, the first command is received from a SpCell; and the TA is received from the SpCell or the first cell.

In some aspects, the first command is received from the first cell; and the TA is received from the first cell or a SpCell.

In some aspects, at least one of the first order, a SSB, or a CSI-RS is received via a beam and wherein the TA is received via the beam.

In some aspects, the method 1300 further includes transmitting a RRC connection request message via the beam. In some cases, the operations of this step refer to, or may be performed by, circuitry for transmitting and/or code for transmitting as described with reference to FIG. 15.

In some aspects, the method 1300 further includes receiving an RRC connection setup message via the beam. In some cases, the operations of this step refer to, or may be performed by, circuitry for receiving and/or code for receiving as described with reference to FIG. 15.

In some aspects, the TA is received via a beam associated with a Type1-PDCCH CSS.

In some aspects, the method 1300 further includes transmitting a RRC connection request message via the beam. In some cases, the operations of this step refer to, or may be performed by, circuitry for transmitting and/or code for transmitting as described with reference to FIG. 15.

In some aspects, the method 1300 further includes receiving an RRC connection setup message via the beam. In some cases, the operations of this step refer to, or may be performed by, circuitry for receiving and/or code for receiving as described with reference to FIG. 15.

In some aspects, transmitting the PRACH comprises: transmitting the PRACH at a power level determined based on at least one of a first active UL BWP or a first active DL BWP for the UE.

In some aspects, the first active UL BWP is selected from a plurality of active UL BWPs, each UL BWP having a different BWP ID; the first active UL BWP has a lowest BWP ID of the different BWP IDs; and transmitting the PRACH on the first cell comprises transmitting the PRACH on the first active UL BWP with a target received power equal to a target received power of the UL BWP.

In some aspects, the first active UL BWP is selected from a plurality of active UL BWPs having configured ROs, each UL BWP having a different BWP ID; the first active UL BWP has a lowest BWP ID of the different BWP IDs; and transmitting the PRACH on the first cell comprises transmitting the PRACH on the first active UL BWP with a target received power equal to a target received power of the UL BWP.

In some aspects, the first active DL BWP is selected from a plurality of active DL BWPs, each DL BWP having a different BWP ID, and the first DL BWP has a lowest BWP ID of the different BWP IDs.

In some aspects, the first active DL BWP is selected from a plurality of active DL BWPs having SSBs, each DL BWP having a different BWP ID, and the first DL BWP has a lowest BWP ID of the different BWP IDs.

In some aspects, the at least one of the first active UL BWP or the first active DL BWP is indicated in a transmission received by the UE.

In some aspects, the power level is determined based on a PL associated with the first active DL BWP; and the PL is determined based on CSI-RS transmitted within the first active DL BWP.

In some aspects, the first command is received from a SpCell.

In some aspects, the method 1300 further includes determining a period, based on at least one of a frequency range of the first cell, a SCS of the SpCell, or an SCS of the first cell, wherein transmitting the PRACH comprises waiting for the period after receiving the first command before transmitting the PRACH. In some cases, the operations of this step refer to, or may be performed by, circuitry for determining and/or code for determining as described with reference to FIG. 15.

In some aspects, transmitting the PRACH comprises transmitting the PRACH during a RO.

In some aspects, the method 1300 further includes selecting the RO based on at least one of a DCI, a SSB, a DL symbol, or a flexible symbol. In some cases, the operations of this step refer to, or may be performed by, circuitry for selecting and/or code for selecting as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations of a Network Entity

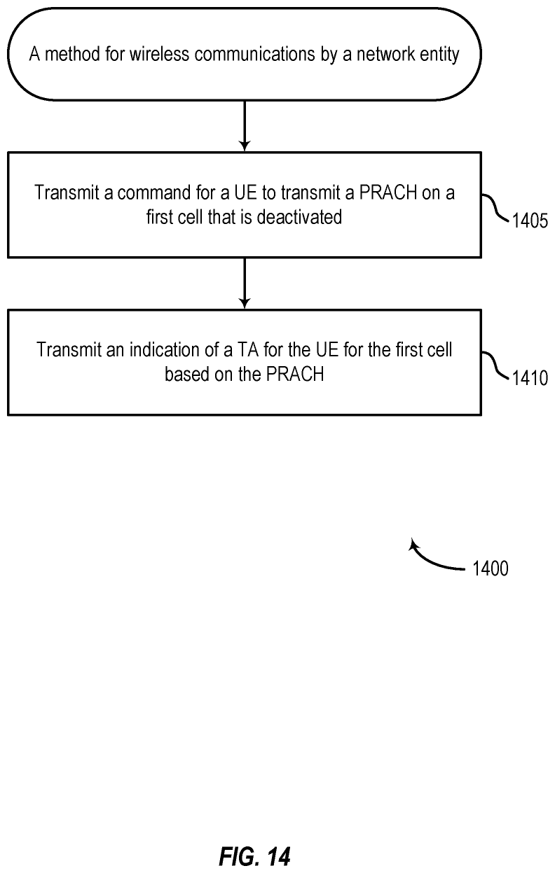

FIG. 14 shows an example of a method 1400 for wireless communications by a network entity, such as a BS 102 of FIGS. 1 and 3, or a disaggregated base station as discussed with respect to FIG. 2.

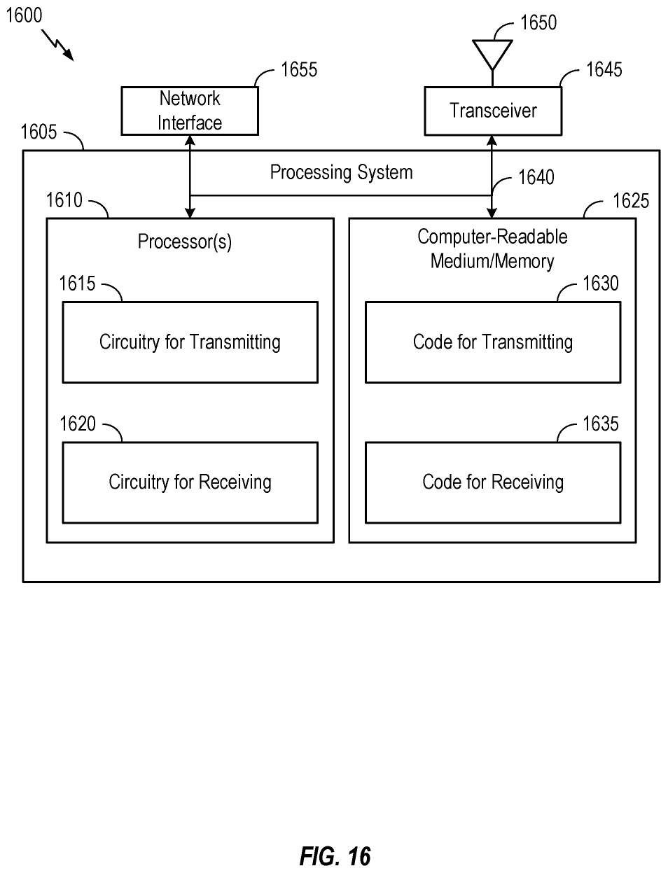

Method 1400 begins at step 1405 with transmitting a command for a UE to transmit a PRACH on a first cell that is deactivated. In some cases, the operations of this step refer to, or may be performed by, circuitry for transmitting and/or code for transmitting as described with reference to FIG. 16.

Method 1400 then proceeds to step 1410 with transmitting an indication of a TA for the UE for the first cell based on the PRACH. In some cases, the operations of this step refer to, or may be performed by, circuitry for transmitting and/or code for transmitting as described with reference to FIG. 16.

In some aspects, the command is transmitted via a SpCell; and the indication of the TA is transmitted via the SpCell or the first cell.

In some aspects, the command is transmitted via the first cell; and the indication of the TA is transmitted via the first cell or a SpCell.

In some aspects, at least one of the order, a SSB, or a CSI-RS is transmitted via a beam and wherein the indication of the TA is transmitted via the beam.

In some aspects, the method 1400 further includes receiving a RRC connection request message via the beam. In some cases, the operations of this step refer to, or may be performed by, circuitry for receiving and/or code for receiving as described with reference to FIG. 16.

In some aspects, the method 1400 further includes transmitting an RRC connection setup message via the beam. In some cases, the operations of this step refer to, or may be performed by, circuitry for transmitting and/or code for transmitting as described with reference to FIG. 16.

In some aspects, the indication of the TA is transmitted via a beam associated with a Type1-PDCCH CSS.

In some aspects, the method 1400 further includes receiving a RRC connection request message via the beam. In some cases, the operations of this step refer to, or may be performed by, circuitry for receiving and/or code for receiving as described with reference to FIG. 16.

In some aspects, the method 1400 further includes transmitting an RRC connection setup message via the beam. In some cases, the operations of this step refer to, or may be performed by, circuitry for transmitting and/or code for transmitting as described with reference to FIG. 16.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as a UE 104 described above with respect to FIGS. 1 and 3.

The communications device 1500 includes a processing system 1505 coupled to the transceiver 1565 (e.g., a transmitter and/or a receiver). The transceiver 1565 is configured to transmit and receive signals for the communications device 1500 via the antenna 1570, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related to it. Note that reference to a processor performing a function of communications device 1500 may include one or more processors 1510 performing that function of communications device 1500.

In the depicted example, computer-readable medium/memory 1535 stores code (e.g., executable instructions), such as code for receiving 1540, code for transmitting 1545, code for determining 1550, and code for selecting 1555. Processing of the code for receiving 1540, code for transmitting 1545, code for determining 1550, and code for selecting 1555 may cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry such as circuitry for receiving 1515, circuitry for transmitting 1520, circuitry for determining 1525, and circuitry for selecting 1530. Processing with circuitry for receiving 1515, circuitry for transmitting 1520, circuitry for determining 1525, and circuitry for selecting 1530 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending or outputting for transmission may include transceivers 354 and/or antenna(s) 352 of the UE 104 illustrated in FIG. 3 and/or the transceiver 1565 and the antenna 1570 of the communications device 1500 in FIG. 15. Means for receiving or obtaining may include transceivers 354 and/or antenna(s) 352 of the UE 104 illustrated in FIG. 3 and/or the transceiver 1565 and the antenna 1570 of the communications device 1500 in FIG. 15.

FIG. 16 depicts aspects of an example communications device 1600. In some aspects, communications device 1600 is a network entity, such as a BS 102 of FIGS. 1 and 3, or a disaggregated base station as discussed with respect to FIG. 2.

The communications device 1600 includes a processing system 1605 coupled to the transceiver 1645 (e.g., a transmitter and/or a receiver) and/or a network interface 1655. The transceiver 1645 is configured to transmit and receive signals for the communications device 1600 via the antenna 1650, such as the various signals as described herein. The network interface 1655 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1625 via a bus 1640. In certain aspects, the computer-readable medium/memory 1625 is configured to store instructions (e.g., computer-executable code) that when executed by the one or more processors 1610, cause the one or more processors 1610 to perform the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1625 stores code (e.g., executable instructions), such as code for transmitting 1630 and code for receiving 1635. Processing of the code for transmitting 1630 and code for receiving 1635 may cause the communications device 1600 to perform the method 1400 described with respect to FIG. 14, or any aspect related to it.

The one or more processors 1610 include circuitry configured to implement (e.g., execute) the code stored in the computer-readable medium/memory 1625, including circuitry such as circuitry for transmitting 1615 and circuitry for receiving 1620. Processing with circuitry for transmitting 1615 and circuitry for receiving 1620 may cause the communications device 1600 to perform the method 1400 as described with respect to FIG. 14, or any aspect related to it.

Various components of the communications device 1600 may provide means for performing the method 1400 as described with respect to FIG. 14, or any aspect related to it. Means for transmitting, sending or outputting for transmission may include transceivers 332 and/or antenna(s) 334 of the BS 102 illustrated in FIG. 3 and/or the transceiver 1645 and the antenna 1650 of the communications device 1600 in FIG. 16. Means for receiving or obtaining may include transceivers 332 and/or antenna(s) 334 of the BS 102 illustrated in FIG. 3 and/or the transceiver 1645 and the antenna 1650 of the communications device 1600 in FIG. 16.

### EXAMPLE CLAUSES

Implementation examples are described in the following numbered clauses:

Clause 1: A method for wireless communications by a UE, comprising: receiving a first command to transmit a PRACH on a first cell that is deactivated; and transmitting the PRACH on the first cell in response to the first command.

Clause 2: The method of Clause 1, further comprising: receiving a TA for the first cell, wherein the TA is determined based on the PRACH; and transmitting a signal to the first cell using the TA.

Clause 3: The method of Clause 2, wherein the first command is received from a SpCell; and the TA is received from the SpCell or the first cell.

Clause 4: The method of Clause 2, wherein the first command is received from the first cell; and the TA is received from the first cell or a SpCell.

Clause 5: The method of Clause 2, wherein at least one of the first order, a SSB, or a CSI-RS is received via a beam and wherein the TA is received via the beam, and the method further comprises: transmitting a RRC connection request message via the beam; and receiving an RRC connection setup message via the beam.

Clause 6: The method of Clause 2, wherein the TA is received via a beam associated with a Type1-PDCCH CSS, and the method further comprises: transmitting a RRC connection request message via the beam; and receiving an RRC connection setup message via the beam.

Clause 7: The method of any one of Clauses 1-6, wherein transmitting the PRACH comprises: transmitting the PRACH at a power level determined based on at least one of a first active UL BWP or a first active DL BWP for the UE.

Clause 8: The method of Clause 7, wherein the first active UL BWP is selected from a plurality of active UL BWPs, each UL BWP having a different BWP ID; the first active UL BWP has a lowest BWP ID of the different BWP IDs; and transmitting the PRACH on the first cell comprises transmitting the PRACH on the first active UL BWP with a target received power equal to a target received power of the UL BWP.

Clause 9: The method of Clause 7, wherein the first active UL BWP is selected from a plurality of active UL BWPs having configured ROs, each UL BWP having a different BWP ID; the first active UL BWP has a lowest BWP ID of the different BWP IDs; and transmitting the PRACH on the first cell comprises transmitting the PRACH on the first active UL BWP with a target received power equal to a target received power of the UL BWP.

Clause 10: The method of Clause 7, wherein the first active DL BWP is selected from a plurality of active DL BWPs, each DL BWP having a different BWP ID, and the first DL BWP has a lowest BWP ID of the different BWP IDs.

Clause 11: The method of Clause 7, wherein the first active DL BWP is selected from a plurality of active DL BWPs having SSBs, each DL BWP having a different BWP ID, and the first DL BWP has a lowest BWP ID of the different BWP IDs.

Clause 12: The method of Clause 7, wherein the at least one of the first active UL BWP or the first active DL BWP is indicated in a transmission received by the UE.

Clause 13: The method of Clause 7, wherein the power level is determined based on a PL associated with the first active DL BWP; and the PL is determined based on CSI-RS transmitted within the first active DL BWP.

Clause 14: The method of any one of Clauses 1-3 or 5-13, wherein the first command is received from a SpCell, and the method further comprises: determining a period, based on at least one of a frequency range of the first cell, a SCS of the SpCell, or an SCS of the first cell, wherein transmitting the PRACH comprises waiting for the period after receiving the first command before transmitting the PRACH.

Clause 15: The method of any one of Clauses 1-14, wherein transmitting the PRACH comprises transmitting the PRACH during a RO, and the method further comprises: selecting the RO based on at least one of a DCI, a SSB, a DL symbol, or a flexible symbol.

Clause 16: A method for wireless communications by a network entity, comprising: transmitting a command for a UE to transmit a PRACH on a first cell that is deactivated; and transmitting an indication of a TA for the UE for the first cell based on the PRACH.

Clause 17: The method of Clause 16, wherein the command is transmitted via a SpCell; and the indication of the TA is transmitted via the SpCell or the first cell.

Clause 18: The method of Clause 16, wherein the command is transmitted via the first cell; and the indication of the TA is transmitted via the first cell or a SpCell.

Clause 19: The method of any one of Clauses 16-18, wherein at least one of the order, a SSB, or a CSI-RS is transmitted via a beam and wherein the indication of the TA is transmitted via the beam, and the method further comprises: receiving a RRC connection request message via the beam; and transmitting an RRC connection setup message via the beam.

Clause 20: The method of any one of Clauses 16-19, wherein the indication of the TA is transmitted via a beam associated with a Type1-PDCCH CSS, and the method further comprises: receiving a RRC connection request message via the beam; and transmitting an RRC connection setup message via the beam.

Clause 21: An apparatus, comprising: a memory comprising executable instructions; and a processor configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by a processor of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
receiving a first command to transmit a physical random access channel (PRACH) on a first cell that is deactivated; and
transmitting the PRACH on the first cell in response to the first command.

2. The method of claim 1, further comprising:
receiving a timing advance (TA) for the first cell, wherein the TA is determined based on the PRACH; and
transmitting a signal to the first cell using the TA.

3. The method of claim 2, wherein:
the first command is received from a special cell (SpCell); and
the TA is received from the SpCell or the first cell.

4. The method of claim 2, wherein:
the first command is received from the first cell, and
the TA is received from the first cell or a special cell (SpCell).

5. The method of claim 1, wherein transmitting the PRACH comprises:
transmitting the PRACH at a power level determined based on at least one of a first active uplink (UL) bandwidth part (BWP) or a first active downlink (DL) BWP for the UE.

6. The method of claim 5, wherein:
the first active UL BWP is selected from a plurality of active UL BWPs, each UL BWP having a different BWP identifier (ID);
the first active UL BWP has a lowest BWP ID of the different BWP IDs; and
transmitting the PRACH on the first cell comprises transmitting the PRACH on the first active UL BWP with a target received power equal to a target received power of the UL BWP.

7. The method of claim 5, wherein:
the first active UL BWP is selected from a plurality of active UL BWPs having configured RACH occasions (ROs), each UL BWP having a different BWP identifier (ID);
the first active UL BWP has a lowest BWP ID of the different BWP IDs; and
transmitting the PRACH on the first cell comprises transmitting the PRACH on the first active UL BWP with a target received power equal to a target received power of the UL BWP.

8. The method of claim 5, wherein the first active DL BWP is selected from a plurality of active DL BWPs, each DL BWP having a different BWP identifier (ID), and the first DL BWP has a lowest BWP ID of the different BWP IDs.

9. The method of claim 5, wherein the first active DL BWP is selected from a plurality of active DL BWPs having synchronization signal blocks (SSBs), each DL BWP having a different BWP identifier (ID), and the first DL BWP has a lowest BWP ID of the different BWP IDs.

10. The method of claim 5, wherein the at least one of the first active UL BWP or the first active DL BWP is indicated in a transmission received by the UE.

11. The method of claim 5, wherein:
the power level is determined based on a path loss (PL) associated with the first active DL BWP; and
the PL is determined based on channel state information reference signals (CSI-RS) transmitted within the first active DL BWP.

12. The method of claim 1, wherein the first command is received from a special cell (SpCell), and the method further comprises:
determining a period, based on at least one of a frequency range of the first cell, a subcarrier spacing (SCS) of the SpCell, or an SCS of the first cell, wherein transmitting the PRACH comprises waiting for the period after receiving the first command before transmitting the PRACH.

13. The method of claim 1, wherein transmitting the PRACH comprises transmitting the PRACH during a RACH occasion (RO), and the method further comprises:
selecting the RO based on at least one of a downlink control information (DCI), a synchronization symbol block (SSB), a downlink (DL) symbol, or a flexible symbol.

14. The method of claim 2, wherein at least one of the first order, a synchronization signal block (SSB), or a channel state information reference signal (CSI-RS) is received via a beam and wherein the TA is received via the beam, and the method further comprises:
transmitting a radio resource control (RRC) connection request message via the beam; and
receiving an RRC connection setup message via the beam.

15. The method of claim 2, wherein the TA is received via a beam associated with a Type 1 physical downlink control channel (Type1-PDCCH) common search space (CSS), and the method further comprises:
transmitting a radio resource control (RRC) connection request message via the beam; and
receiving an RRC connection setup message via the beam.

16. A method for wireless communications by a network entity, comprising:
transmitting a command for a UE to transmit a physical random access channel (PRACH) on a first cell that is deactivated; and
transmitting an indication of a timing advance (TA) for the UE for the first cell based on the PRACH.

17. The method of claim 16, wherein:
the command is transmitted via a special cell (SpCell); and
the indication of the TA is transmitted via the SpCell or the first cell.

18. The method of claim 16, wherein:
the command is transmitted via the first cell, and
the indication of the TA is transmitted via the first cell or a special cell (SpCell).

19. The method of claim 16, wherein at least one of the order, a synchronization signal block (SSB), or a channel state information reference signal (CSI-RS) is transmitted via a beam and wherein the indication of the TA is transmitted via the beam, and the method further comprises:
receiving a radio resource control (RRC) connection request message via the beam; and
transmitting an RRC connection setup message via the beam.

20. The method of claim 16, wherein the indication of the TA is transmitted via a beam associated with a Type 1 physical downlink control channel (Type1-PDCCH) common search space (CSS), and the method further comprises:
receiving a radio resource control (RRC) connection request message via the beam; and
transmitting an RRC connection setup message via the beam.

21. An apparatus, comprising: at least one memory comprising instructions; and at least one processor configured to execute the instructions and cause the apparatus to:
receive a first command to transmit a physical random access channel (PRACH) on a first cell that is deactivated; and
transmit the PRACH on the first cell in response to the first command.

22-24. (canceled)
